(19) United States
(12) Patent Application Publication
(10) Pub. No.: US 2026/0046245 A1
(43) Pub. Date: Feb. 12, 2026

(54) Enablement of Path Monitoring in Multi-Path Networks

(71) Applicant: Cisco Technology, Inc., San Jose, CA (US)

(72) Inventors: Clarence Filsfils, Brussels (BE); Pablo Camarillo, madrid (ES); Jisu Bhattacharya, San Jose, CA (US); John W. Bettink, San Jose, CA (US)

(21) Appl. No.: 18/798,620

(22) Filed: Aug. 8, 2024

(51) Int. Cl. H04L 45/00; H04L 45/125

(52) U.S. Cl. CPC H04L 45/566; H04L 45/125

(57) ABSTRACT

Devices, systems, methods, and processes for enabling path monitoring in multi-path networks are described herein. Load balancing of packets is often performed based on outer encapsulating headers and inner packet headers. However, inner packet headers of probe and data packets can be different. Thus, the probe packet can traverse a different path as compared to the data packet, causing inconsistent hashing. To address this, a device is provided with a routing logic that encapsulates a packet, having a packet header, with an outer header. The outer header has a control bit, source and destination address fields, and a flow label field. When a value of the control bit is set to a predetermined value, load balancing is performed exclusively based on the outer header, exempting a utilization of the packet header. Therefore, load balancing for probe and data packets performed exclusively based on the outer header is consistent.

The present disclosure relates to communication networks. More particularly, the present disclosure relates to enablement of path monitoring in multi-path communication networks.

### BACKGROUND

Data transmitted over a network is typically sent in the form of packets or frames. These packets travel from one hop to the next within the network. The packets can be transmitted in accordance with one or more routing techniques such as an equal-cost multi-path (ECMP) routing technique, or the like. Routing decisions are often made by calculating load balancing keys (for example, hash values) for each packet.

Generally, a hash value for a packet is derived based on one or more fields within an encapsulating header as well as one or more fields within an original packet header of the packet. For example, the load balancing keys often incorporate Layer 3 (L3) and Layer 4 (L4) fields of an outer encapsulating header, as well as L3/L4 fields of an inner original packet header. Consequently, such hash-based routing decisions for probe packets invariably differ from those of actual data packets, even when their encapsulations are identical.

This inherent discrepancy prevents probe packets used for network monitoring and service performance measurement from following the same paths as corresponding user data traffic. As a result, network operators may be unable to ensure that probe packets traverse the identical paths taken by user data, making it difficult to accurately monitor the specific paths user data travels. Thus, network issues may not be accurately diagnosed, and timely measures to address path-specific degradation may not be implemented. Without accurate monitoring of the actual data paths, delivering guaranteed Service Level Agreements (SLAs) can become challenging.

### SUMMARY OF THE DISCLOSURE

Systems and methods for enabling path monitoring in multi-path networks in accordance with embodiments of the disclosure are described herein. In many embodiments, a device including a processor, a network interface controller configured to provide access to a network, and a memory communicatively coupled to the processor, is provided. The memory includes a routing logic that is configured to receive a packet having a packet header and encapsulate the packet with an outer header. The outer header includes at least one control bit. The routing logic is further configured to assign a predetermined value to the at least one control bit. The at least one control bit having the predetermined value is configured to exempt a utilization of the packet header from a load balancing operation at a next hop. The routing logic is further configured to transmit the encapsulated packet to the next hop.

In a number of embodiments, the at least one control bit having the predetermined value is further configured to indicate a utilization of the outer header for the load balancing operation at the next hop.

In a variety of embodiments, the outer header comprises at least one of a Flow Label field or a Type of Service (ToS) field.

In more embodiments, the Flow Label field includes the at least one control bit.

In further embodiments, the at least one control bit is included in the ToS field.

In additional embodiments, the outer header further includes at least one of a source address field or a destination address field.

In still more embodiments, the at least one control bit having the predetermined value is further configured to indicate a utilization of at least one of the source address field, the destination address field, and the Flow Label field, in the outer header, for the load balancing operation at the next hop.

In yet more embodiments, prior to assigning the predetermined value to the at least one control bit, the routing logic is further configured to determine a requirement to assign the predetermined value to the at least one control bit.

In still yet more embodiments, the routing logic is further configured to determine the requirement to assign the predetermined value to the at least one control bit based on a set of flow parameters.

In many further embodiments, the set of flow parameters includes a service level agreement parameter.

In further additional embodiments, the packet corresponds to a data packet.

In still further embodiments, the packet corresponds to a probe packet.

In yet further embodiments, the probe packet is configured to monitor a path traversed by a data packet in the network.

In several embodiments, the routing logic is further configured to set an entropy of the probe packet same as the data packet.

In numerous embodiments, a device including a processor, a network interface controller configured to provide access to a network, and a memory communicatively coupled to the processor, is provided. The memory includes a routing logic that is configured to receive an encapsulated packet including a packet header and an outer header. The outer header includes at least one control bit. The routing logic is further configured to determine whether the at least one control bit is assigned with a predetermined value and perform a load balancing operation on the encapsulated packet by exclusively utilizing the outer header in response to determining that the at least one control bit is assigned with the predetermined value.

In several additional embodiments, the at least one control bit having the predetermined value is configured to exempt a utilization of the packet header from the load balancing operation.

In several more embodiments, the routing logic is further configured to transmit the encapsulated packet to a next hop based on the load balancing operation.

In numerous additional embodiments, the outer header includes a source address field, a destination address field, and a Flow Label field.

In still yet further embodiments, the routing logic performs the load balancing operation based on at least one of the source address field, the destination address field, and the Flow Label field, of the outer header.

In still yet additional embodiments, a method includes receiving a packet having a packet header, encapsulating the packet with an outer header, wherein the outer header includes at least one control bit, and assigning a predetermined value to the at least one control bit. The at least one control bit having the predetermined value is configured to exempt a utilization of the packet header from a load balancing operation at a next hop. The method further includes transmitting the encapsulated packet to the next hop.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic diagram of an example network architecture, in accordance with various embodiments of the disclosure;

FIG. 2 is a schematic diagram of another example network architecture, in accordance with various embodiments of the disclosure;

FIG. 3 is a schematic diagram of another example network architecture, in accordance with various embodiments of the disclosure;

FIG. 4 is a flowchart showing a process for load balancing in a multi-path network, in accordance with various embodiments of the disclosure;

FIG. 5 is a flowchart showing a process for load balancing of a probe packet, in accordance with various embodiments of the disclosure;

FIG. 6 is a flowchart showing a process for routing a packet, in accordance with various embodiments of the disclosure;

FIG. 7 is a flowchart showing a process for load balancing in a multi-path network, in accordance with various embodiments of the disclosure;

FIG. 8 is a flowchart showing a process for routing a packet, in accordance with various embodiments of the disclosure; and

FIG. 9 is a conceptual block diagram of a device suitable for configuration with a routing logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are described herein that can enable path monitoring in multi-path networks. Data transmitted over a network is typically sent in the form of packets or frames. These packets travel from one hop to the next within the network. The packets can be transmitted in accordance with one or more routing techniques such as an equal-cost multi-path (ECMP) routing technique, or the like.

Routing decisions are often made by calculating load balancing keys (for example, hash values) for each packet. Generally, a hash value for a packet is derived based on one or more fields within an encapsulating header as well as one or more fields within an original packet header of the packet. Consequently, such hash-based routing decisions for probe packets invariably differ from those of actual data packets, even when their encapsulations are identical. This inherent discrepancy may prevent probe packets used for network monitoring and service performance measurement from following the same paths as corresponding user data traffic. As a result, network operators may be unable to ensure that probe packets traverse the identical paths taken by the user data, making it difficult to accurately monitor the specific paths user data travels. Thus, network issues may not be accurately diagnosed, and timely measures to address path-specific degradation may not be implemented. Without accurate monitoring of the actual data paths, delivering guaranteed Service Level Agreements (SLAs) can become challenging.

In many embodiments, an edge device (for example, a network device) may receive a packet with a packet header. The packet can be a data packet or a probe packet, associated with a traffic flow. The edge device may be configured to encapsulate the packet with an outer header. The outer header may include various fields, for example, a source address field, a destination address field, a flow label field, or the like. The flow label field may include a plurality of bits including at least one control bit. In those embodiments where probe packets are utilized for network monitoring and service performance measurement for the traffic flow, the edge device may be configured to set a value of the control bit to a predetermined value (for example, SET). The value of the control bit when set to the predetermined value may indicate an exemption of the packet header from being utilized for load balancing operations on the packet. In other words, based on the value of the control bit being the predetermined value, the load balancing operations on the packet can be performed exclusively based on the outer header of the packet. Subsequentially, the edge device may transmit the encapsulated packet to a next hop (for example, an intermediate network device).

In several embodiments, prior to setting the value of the control bit, the edge device may be further configured to determine whether there is a requirement for setting the value of the control bit to the predetermined value. For determining the requirement, the edge device may receive a set of flow parameters from a source of the packet. The set of flow parameters may be indicative of one or more SLAs associated with the traffic flow. In many scenarios, one or more SLAs may require data or network to be monitored. In such scenarios, the edge device may determine a requirement for setting the value of the control bit to the predetermined value. Upon determining such a requirement, the edge device may set the value of the control bit of the packet to the predetermined value (for example, SET).

In several additional embodiments, one or more bits of the flow label field may be indicative of an entropy of the packet. In a scenario where the packet corresponds to a probe packet utilized for monitoring the traffic flow, the entropy of the probe packet can be set to be the same as entropy of one or more data packet of the traffic flow.

In a variety of embodiments, the intermediate network device, upon receiving the encapsulated packet, may determine whether the value of the control bit in the outer header of the encapsulated packet is set to the predetermined value or not. In a scenario where the intermediate network device determines that the value of the control bit in the outer header of the encapsulated packet is set to the predetermined value, the intermediate network device may perform a load balancing operation on the packet exclusively based on the outer header. For example, the intermediate network device may utilize the source address field, the destination address field, and the flow label field in the outer header (e.g., an outer encapsulating header) for performing the load balancing operation on the packet. In other words, the intermediate network device exempts a utilization of the inner packet header from the load balancing operation.

In more embodiments, the outer header may further include a next header field. In such embodiments, upon encapsulating the packet, the edge device may be configured to determine whether there is a requirement to obfuscate the next header field. The edge device may determine such requirement based on the set of flow parameters. Based on the determination that there is a requirement to obfuscate the next header field, the edge device may set a value of the next header field to an unrecognized next header type. Thus, when the intermediate network device receives the encapsulated packet with the obfuscated next header field, the intermediate network device may not be able to recognize, read, or extract the value of the next header field from the packet header. Therefore, the intermediate network device may perform the load balancing operation for the packet exclusively based on the outer header. In other words, by obfuscating the next header field in the outer encapsulating header, the utilization of the packet header for the load balancing operation at the intermediate network device is exempted.

Thus, an edge device that can enable path monitoring in multi-path networks may be provided. For example, by setting the control bit in the outer encapsulating header to the predetermined value or by obfuscating the next header field in the outer encapsulating header, the edge device ensures that probe packets associated with a traffic flow would traverse the same path as data packets of the traffic flow. Consequently, accurate monitoring of the actual data paths is enabled and guaranteed SLAs can be delivered. In other words, the edge device enables deterministic path monitoring and ensures accurate SLA enforcement. The edge device further provides service providers with tools to maintain high service quality and meet stringent requirements in today's networking applications.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” “module,” “apparatus,” or “system. ” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in still yet more embodiments, may alternatively be embodied by or implemented as a component.

A circuit, as used herein, comprises a set of one or more electrical and/or electronic components providing one or more pathways for electrical current. In many additional embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to the ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more”unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C. ” An exception to this definition will occur only when a combination of elements, functions, steps, or acts are in some way inherently mutually exclusive.

Aspects of the present disclosure are described below with reference to schematic flowchart diagrams and/or or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

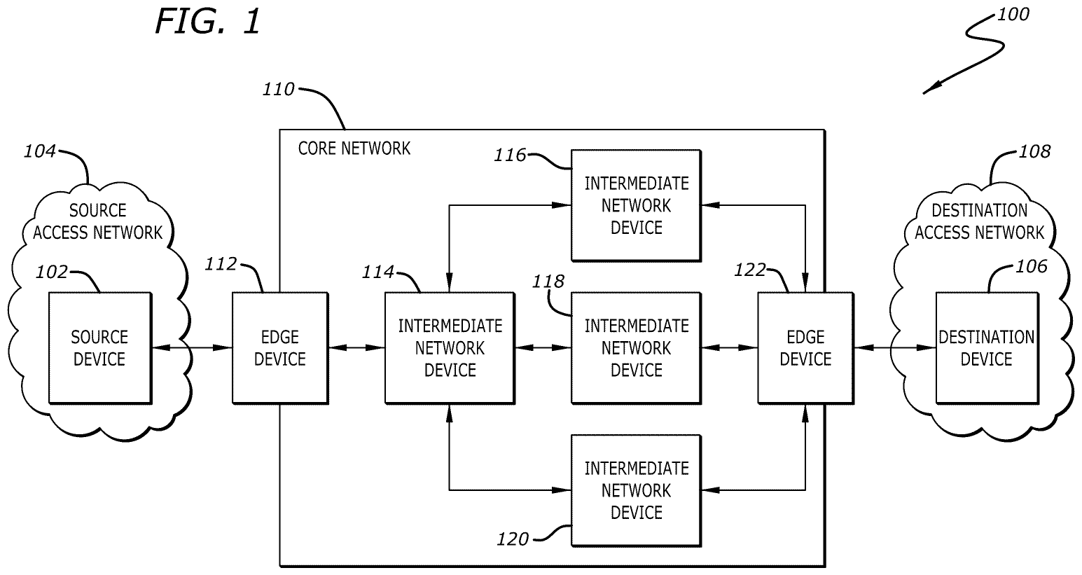

Referring to FIG. 1, a schematic diagram of an example network architecture 100 in accordance with various embodiments of the disclosure is shown. In the embodiments depicted in FIG. 1, the network architecture 100 may include a source device 102 associated with a source access network 104 and a destination device 106 associated with a destination access network 108. The source device 102 and the destination device 106 may communicate with each other via a core network 110. The source device 102 may be coupled with the core network 110 via a first edge device 112. The core network 110 may include one or more intermediate network devices, for example, intermediate network devices 114-120. The first edge device 112 can be coupled with any of the intermediate network devices 114-120 in the core network 110. For example, in FIG. 1, the first edge device 112 is shown to be communicatively coupled to the intermediate network device 114. The destination device 106 can be coupled with the core network 110 via a second edge device 122. Further, the second edge device 122 can be coupled with any of the intermediate network devices in the core network 110. For example, in FIG. 1, the second edge device 122 is shown to be communicatively coupled to the intermediate network devices 116-120. Notably, the intermediate network devices 114-120 form multiple paths/routes between the first edge device 112 and the second edge device 122. In other words, the intermediate network devices 114-120 form multiple paths/routes between the source device 102 and the destination device 106.

In many embodiments, the source access network 104 may include, for example, a first group of network devices that are in communication with one another via one or more wired or wireless links. Examples of the source access network 104, may include, but are not limited to, wide area networks (WANs), local area networks (LANs), neighborhood area networks (NANs), personal area networks (PANs), home area networks (HANs), or Field Area Networks (FANs). In further embodiments, the first group of network devices in the source access network 104 may form an overlay network that enables communication of frames and packets by the group of network devices. The first group of network devices may include, but are not limited to, a router, a personal computer, a repeater, a hub, a switch, an end user device, one or more enterprise devices, or the like.

For the sake of illustration, only one source device (for example, the source device 102) is shown to be included in the source access network 104 in FIG. 1. However, in practical implementations, the source access network 104 may include any number of network devices without deviating from the scope of the disclosure.

In a number of embodiments, the destination access network 108 may include a second group of network devices that are in communication with one another via one or more wired or wireless links. Examples of the destination access network 108, may include but are not limited to, WANs, LANs, NANs, PANs, HANs, FANs, or other similar networks. The second group of network devices in the destination access network 108 may form another overlay network that enables communication of frames and packets by the second group of devices. Examples of the second group of network devices may include, but are not limited to, a router, a personal computer, a repeater, a hub, a switch, an end user device, one or more enterprise devices, or the like. For the sake of illustration, only one destination device 106 is shown to be included in the destination access network 108 in FIG. 1. However, in practical implementations, the destination access network 108 may include any number of network devices without deviating from the scope of the disclosure.

In a variety of embodiments, the core network 110 may include a group of intermediate network devices that form various communication channels (for example, a path, a route, a tunnel, or the like) between the source access network 104 and the destination access network 108. For example, the intermediate network devices 114 and 116 may form a communication channel between the first and second edge devices 112 and 122. In other words, the intermediate network devices 114 and 116 may form a communication channel between the source device 102 and the destination device 106. The communication channel can be implemented by way of one or more wired or wireless links. Examples of the core network 110 may include, but are not limited to, WANs, LANs, NANs, PANs, HANs, and FANs. In many examples, the group of intermediate network devices in the core network 110 may form an underlay network that enables communication of frames and packets by the group of intermediate network devices. Examples of the intermediate network devices 114-120 may include, but are not limited to, routers, repeaters, hubs, switches, access points, firewalls, or the like. For the sake of illustration, only four intermediate network devices (for example, the intermediate network devices 114-120) are shown to be included in the core network 110 in FIG. 1. However, in practical implementations, the core network 110 can include any number of intermediate network devices without deviating from the scope of the disclosure.

In additional embodiments, the first edge device 112 that couples the source access network 104 with the core network 110 may support network protocols associated with the source access network 104 as well as the core network 110. For example, the first edge device 112 may support Internet Protocol version 4 (IPv4) and IPv6 protocols if the source access network 104 conforms to IPv4 protocol and the core network 110 conforms to IPv6 protocol. The first edge device 112 may generate and route packets and frames that are compatible with the first group of devices in the source access network 104 and the group of intermediate network devices in the core network 110.

In still more embodiments, the first edge device 112 may include a first processor, a first network interface controller, and a first memory coupled to the first processor. The first memory may include a routing logic that when executed by the first processor can perform one or more operations to transform packets associated with a data traffic in a way that the packets get routed on the same path to reach thier destination. The first network interface controller may provide access to the source access network 104 and the core network 110.

In still further embodiments, the second edge device 122 that couples the destination access network 108 with the core network 110 may support network protocols associated with the destination access network 108 as well as the core network 110. For example, the second edge device 122 may support IPv4 and IPv6 protocols if the destination access network 108 conforms to IPv4 protocol and the core network 110 conforms to IPv6 protocol. The second edge device 122 may include a second processor, a second network interface controller, and a second memory coupled to the second processor. The second memory may include a routing logic that when executed by the second processor can perform one or more operations for load balancing.

In still additional embodiments, the source device 102 may require communicating a message to the destination device 106. The source device 102 may divide the message into a plurality of data packets. Notably, communication of the message to the destination device 106 may have to be performed while adhering to a set of service level agreements (SLAs). Therefore, the source device 102 may also be required to communicate one or more probe packets to perform path discovery, network monitoring, latency assessment, delay point detection, network throughput assessment, Quality of Service (QoS) detection, network troubleshooting, or the like. As a result, the source device 102 may communicate a probe packet followed by the plurality of data packets to the destination device 106.

In a multi-path network (for example, the core network 110), load balancing operations may be performed on a traffic flow from the source device 102 to destination device 106 to ensure efficient and reliable data transmission. Examples of such load balancing operations may include hashing-based routing techniques. A load balancing operation can be performed at a current hop (for example, an intermediate network device) to determine a next hop for a packet associated with the traffic flow. Conventional network devices utilize contents of an inner packet header and an outer encapsulating header of a packet to derive a load balancing key for the packet. As a result, load balancing keys of data packets and probe packets associated with the same traffic flow can be different from one another. Therefore, the probe packets can be routed through different paths than the data packets. Hence, the probe packets may not be able to monitor the network path the data packets follow. Thus, delivering guaranteed SLAs becomes challenging with the conventional path monitoring solutions. However, in the present disclosure, the routing logic implemented at the first edge device 112 and the second edge device 122 may perform one or more operations to overcome the shortcomings of conventional path monitoring solutions.

In yet more embodiments, the source device 102 may communicate a packet with a packet header (for example, an IPv4 header) to the first edge device 112. The packet header may include a source address, a destination address, a protocol, a port number, or the like associated with the packet. The packet can be an actual data packet or a probe packet associated with a traffic flow for which a set of SLAs needs to be guaranteed. Upon receiving the packet, the first edge device 112 may be configured to encapsulate the packet with an outer header (for example, an IPv6 header). The outer header (interchangeably referred to as “outer encapsulating header”) may include various fields, for example, a source address field, a destination address field, a flow label field, or the like. The source address field may include a source address of the packet and the destination address field may include a destination address of the packet. The flow label field may include a plurality of bits of which one is a control bit and other bits can be utilized to indicate an entropy of the traffic flow. The control bit is a Boolean bit that can be either ‘SET’ or ‘UNSET’. The control bit having a predetermined value (e.g., the value ‘SET’, ‘1’, ‘True’, or the like) may be configured to indicate a constraint that a subsequent hop of the packet should perform load balancing operations on the packet exclusively based on the outer header and should exempt the utilization of the packet header for the load balancing operations. Alternatively, the control bit having the value ‘UNSET’ (or ‘0’, ‘False’, or the like) may be configured to indicate that the subsequent hop can utilize both the packet header and the outer header for performing the load balancing operations on the packet.

In still yet more embodiments, the first edge device 112 may transmit the encapsulated packet with the value of the control bit set to the predetermined value ‘SET’ to a next hop (for example, the intermediate network device 114). The intermediate network device 114 may check the value of the control bit in the encapsulated packet and determine which portions of the packet can be used for performing the load balancing operations. For example, if the control bit has the value ‘UNSET’, the intermediate network device 114 may perform the load balancing operations on the packet utilizing both the packet header and the outer header. In other words, if the control bit has the value ‘UNSET’, the intermediate network device 114 may determine a load balancing key for the packet based on the contents of the packet header and the outer header. The load balancing key may be utilized for performing a load balancing operation on the packet for routing the packet. However, if the control bit has the predetermined value ‘SET’, the intermediate network device 114 may determine that the load balancing operations on the packet can be performed by utilizing only the outer header of the packet. In other words, the packet header of the packet may be exempted from utilization for the load balancing operation.

In still yet further embodiments, when the packet header may be exempted from performing the load balancing operations on the packet, the intermediate network device 114 may use the contents of the outer header for load balancing. As mentioned previously, the outer header may include the source address, the destination address, and the flow label fields. The intermediate network device 114 may use the source address, the destination address, and the flow label fields in the outer header for performing the load balancing operation on the packet. The intermediate network device 114 may determine a load balancing key based on the source address, the destination address, and the flow label fields in the outer header. Subsequently, the intermediate network device 114 may determine a subsequent hop (for example, the intermediate network device 116) for the packet. Likewise, the other intermediate network devices may also route the packet based on the outer header and may transmit the packet to the second edge device 122, which transmits the packet to the destination device 106.

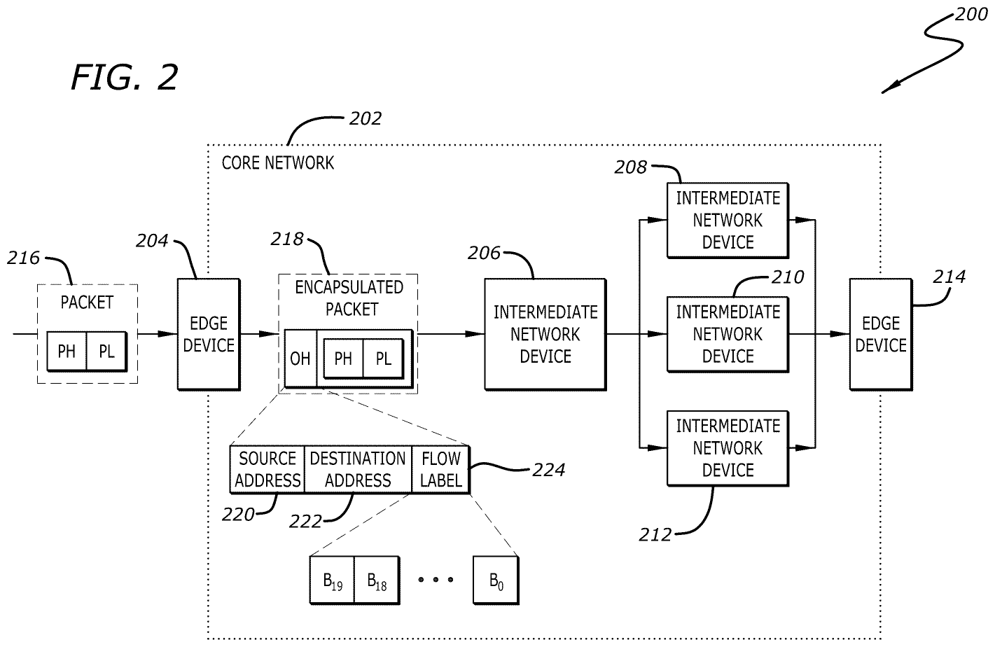

Although a specific embodiment for a network architecture suitable for carrying out the various steps, processes, methods, and operations described herein is discussed with respect to FIG. 1, any of a variety of systems and/or processes may be utilized in accordance with embodiments of the disclosure. For example, the first edge device 112 may be further configured to receive a start instruction indicating the start of a traffic flow and a stop instruction indicating the end of the traffic flow. In many further embodiments, the control bit can be included in any other field of the outer header (for example, a type of service “TOS” field or any other field) and is not limited to be only included in the flow label field of the outer header. The elements depicted in FIG. 1 may also be interchangeable with other elements of FIGs. 2-9 as required to realize a particularly desired embodiment.

Referring to FIG. 2, a schematic diagram of another example network architecture 200 in accordance with various embodiments of the disclosure is shown. The embodiments shown in FIG. 2 may illustrate a scenario where the network architecture 200 includes a core network 202 coupled with a first edge device 204. The core network 202 may include a plurality of intermediate network devices 206-212. The plurality of intermediate network devices 206-212 may form a plurality of channels/paths/routes between the first edge device 204 and a second edge device 214.

In numerous embodiments, the first edge device 204 may include a first processor, a first network interface controller, and a first memory coupled to the first processor. The first memory may include a routing logic that when executed by the first processor can perform one or more operations for load balancing.

In many embodiments, the second edge device 214 may include a second processor, a second network interface controller, and a second memory coupled to the second processor. The second memory may include a routing logic that when executed by the second processor can perform one or more operations for load balancing.

In a number of embodiments, the first edge device 204 may receive a packet 216. The packet 216 may include a packet header PH and a payload PL. The packet header PH may include a source address field having a source address of the packet 216 and a destination address field having a destination address of the packet 216. For example, upon receiving the packet 216, the first edge device 204 may encapsulate the packet 216 to obtain an encapsulated packet 218.

As shown, the encapsulated packet 218 may include an outer header OH encapsulating the packet 216. The outer header OH may include various fields of which a source address field 220 having a source address, a destination address field 222 having a destination address, a flow label field 224 are shown. The outer header OH may include may further include a ToS field. The source address in the source address field 220 may be an IP address or a media access control (MAC) address of a source of the packet 216. The destination address in the destination address field 222 may be an IP address or a MAC address of a destination of the packet 216. The flow label field 224 may include a plurality of bits, for example, bits B₀-B₁₉. The plurality of bits B₀-B₁₉ may include a control bit and one or more entropy bits. For example, the bit B₁₉ may be designated as the control bit B₁₉ and bits B₀- B₁₅ may be designated as entropy bits B₀- B₁₅.

In various embodiments, the control bit B₁₉ may be configured to indicate what portions of the encapsulated packet 218 can be used for performing load balancing operations on the encapsulated packet 218. For example, if the control bit B₁₉ has a predetermined value, it may indicate that only the outer header OH of the encapsulated packet 218 can be utilized for performing the load balancing operations on the encapsulated packet 218 and other portions (for example, the packet header PH, internal metadata, payload PL, or the like) of the encapsulated packet 218 may be exempted from utilization for load balancing. However, if the control bit B₁₉ does not have the predetermined value, it may indicate that the outer header OH and other portions (for example, the packet header PH, internal metadata, payload PL, or the like) of the encapsulated packet 218 can be utilized for performing the load balancing operations on the encapsulated packet 218.

In numerous embodiments, the entropy bits B₀-B₁₅ of various packets (e.g., data packets or probe packets) associated with the same traffic flow may be set to have the same entropy value. For example, the first edge device 204 may designate unique entropy values to different traffic flow identifiers. A traffic flow identifier may be an identifier utilized for uniquely identifying a traffic flow. Thus, the first edge device 204 may recognize a traffic flow identifier associated with the encapsulated packet 218 and may update the entropy bits B₀- B₁₅ to indicate the entropy value designated to the recognized traffic flow identifier. In a scenario where the recognized traffic flow identifier is a new identifier, the first edge device 204 may designate a new entropy value to the recognized traffic flow identifier and update the entropy bits B₀-B₁₅ of the encapsulated packet 218 accordingly. Further, the packets with the same entropy value may have to be routed via the same path.

In further additional embodiments, the first edge device 204 may determine whether there is a requirement to set the control bit B₁₉ to the predetermined value. The first edge device 204 may determine such a requirement based on a set of flow parameters. The first edge device 204 may receive the set of flow parameters from a source of the packet 216. The set of flow parameters may include an SLA parameter. The SLA parameter may be indicative of one or more constraints that may have to be adhered to while communicating the packet 216. In an example, the set of flow parameters may include a maximum allowed latency associated with the communication of the packet 216, a geographical location associated with storage of the payload PL within the packet 216, a hop limit associated with the communication of the packet 216, or the like. In an example, if the set of flow parameters may indicate that the packet 216 is a probe packet, the first edge device 204 may detect the requirement to set the control bit B₁₉ to the predetermined value. In a variety of embodiments, when the set of flow parameters indicates the requirement to set the control bit B₁₉ to the predetermined value, the first edge device 204 may be configured to set the value of the control bit B₁₉ to the predetermined value ‘SET’.

In numerous additional embodiments, the first edge device 204 may transmit the encapsulated packet 218 to the intermediate network device 206. The intermediate network device 206 may include a third processor, a third network interface controller configured to connect the intermediate network device 206 to the network, and a third memory. The third memory may include a routing logic that when executed by the third processor may perform one or more operations for routing encapsulated packets.

In yet various embodiments, the intermediate network device 206 may read the outer header OH of the encapsulated packet 218. The intermediate network device 206 may determine whether the value of the control bit B₁₉ is set to the predetermined value ‘SET’ or not. In the current example, the intermediate network device 206 may determine that the value of the control bit B₁₉ is set to the predetermined value ‘SET’. As a result, the intermediate network device 206 may be configured to exempt the utilization of the packet header PH for performing load balancing operations on the encapsulated packet 218. Subsequently, the intermediate network device 206 may perform one or more load balancing operations on the encapsulated packet 218 exclusively based on the outer header OH.

In many further embodiments, for performing the load balancing operations, the intermediate network device 206 may be configured to determine a load balancing vector for the encapsulated packet 218. For example, the intermediate network device 206 may determine the load balancing vector for the encapsulated packet 218 based on the source address field 220, the destination address field 222, and the flow label field 224 (e.g., the entropy bits B₀-B₁₅). Further, the intermediate network device 206 may generate a load balancing key (for example, a hash value) based on the load balancing vector. In an example, the intermediate network device 206 may utilize a hash-based routing technique to generate the load balancing key from the load balancing vector. The intermediate network device 206 may then utilize the load balancing key to determine a next hop (e.g., any of the intermediate network devices 208-212) for the encapsulated packet 218. For example, the intermediate network device 206 may use the hash value and determine that the next hop for the encapsulated packet 218 is the intermediate network device 208.

Likewise, the intermediate network device 208 may also determine a load balancing key for the encapsulated packet 218 based on the outer header OH and route the encapsulated packet 218 to the second edge device 214. The second edge device 214 may further transmit the packet 216, after de-encapsulation, to a destination of the packet 216. Since the outer headers OH of a probe packet and a data packet associated with the same traffic flow are identical, load balancing keys determined for the data packet and the probe packet exclusively based on the outer header OH may also be the same. Hence, the intermediate network devices 206 - 212 may route such data packets and probe packets of the same traffic flow via the same path.

In an example, the first edge device 204 may receive a data packet (IPv4[SA: 1.1.1.1, DA: 3.3.3.3], TCP[ . . . ]), where SA may be a source address of the packet, DA may be a destination address of the packet, and TCP may be a protocol associated with transmission of the packet. Upon reception of the data packet, the first edge device 204 may encapsulate the data packet. Subsequentially, the first edge device 204 may determine whether there is a requirement to set a value of the control bit in an outer encapsulating header of the data packet to the predetermined value. Based on the determination of such a requirement, the first edge device 204 may be to set the control bit to the predetermined value. The first edge device 204 may then transmit the encapsulated data packet with the value of the control bit set to the predetermined value to a next hop. The transmitted encapsulated data packet may be (IPv6[SA:2001:db8:AAAA::, DA 2011:db8:BBBB::, FlowLabel[19]:1, FlowLabel[18:0]: entropy, IPv4[SA: 1.1.1.1, DA: 3.3.3.3], TCP[ . . . ]). Notably, in the encapsulated data packet, the control bit (e.g., FlowLabel[19]) is set to ‘1’ (e.g., the predetermined value). Thus, implying that every transit router that performs load balancing for the encapsulated data packet can only utilize the IPv6 header (e.g., the outer header of the encapsulated data packet). In other words, the encapsulated data packet may be routed exclusively based on the outer header and all other fields of the IPv6 header and the IPv4 header may be exempted from utilization for load balancing.

Notably, a traffic flow of the data packet (IPv4[SA: 1.1.1.1, DA: 3.3.3.3], TCP[ . . . ]) may require a strict guaranteed SLA. Therefore, prior to transmitting the data packet, a probe packet (IPv4[SA: 1.1.1.1, DA: 3.3.3.3], UDP, TWAMP) may be transmitted to monitor the path the data packet (IPv4[SA: 1.1.1.1, DA: 3.3.3.3], TCP[ . . . ]) will traverse. Upon receiving the probe packet (IPv4[SA: 1.1.1.1, DA: 3.3.3.3], UDP, TWAMP), the first edge device 204 may encapsulate the probe packet with an IPv6 header. The encapsulated probe packet may be (IPV6[SA: 2001:db8:AAAA::, DA: 2011:db8:BBBB::, FlowLabel[19]:1, FlowLabel[18:0]:same entropy as the data packet (IPv4[SA: 1.1.1.1, DA: 3.3.3.3], TCP[ . . . ]). Subsequentially, the first edge device 204 may transmit the encapsulated probe packet to a next hop which may be the same next hop as for the encapsulated data packet.

At the intermediate networking device, the control bit in the encapsulated packet (e.g., the encapsulated data packet or the encapsulated probe packet) may be checked. Based on the value of the control bit being the predetermined value, the intermediate network device may perform load balancing operations on the encapsulated packet exclusively based on the outer header and route the encapsulated packet based on the load balancing operations. Thus, achieving consistent hashing for the data packets and the probe packets.

In numerous embodiments, the encapsulated packet 218 may further include segment routing (SR) v6 segments that are identified using segment identifiers (SIDs) encoded as IPv6 addresses. An End.DT4 SID is a provider edge (PE)-specific endpoint SID that identifies an IPv4 VPN instance. The End.DT4 SID in the encapsulated packet 218 instructs the second edge device 214 to decapsulate the encapsulated packet 218 and identify next-hop for packet forwarding. An End.DX2 SID is a Layer 2 cross-connect endpoint SID that identifies an endpoint. The End.DX2 SID in the encapsulated packet 218 instructs the second edge device 214 to pop the IPv6 header and extension headers and then forward the remaining packet content to a next-hop based on the End.DX2 SID.

Although a specific embodiment for an example network architecture with load balancing based on a value of control bit suitable for carrying out the various steps, processes, methods, and operations described herein is discussed with respect to FIG. 2, any of a variety of systems and/or processes may be utilized in accordance with embodiments of the disclosure. For example, the packet 216 may further include a flow parameter field that may include the set of flow parameters. The first edge device 204 may be further configured to extract the set of flow parameters from the flow parameter field to determine whether there is a requirement to set the value of the control bit to the predetermined value. The elements depicted in FIG. 2 may also be interchangeable with other elements of FIGS. 1 and 3-9 as required to realize a particularly desired embodiment.

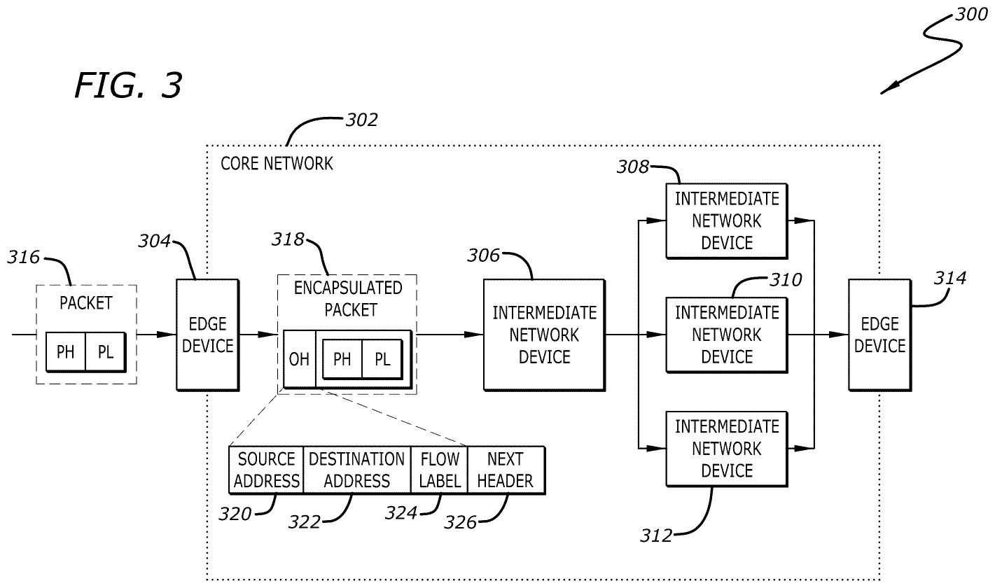

Referring to FIG. 3, a schematic diagram of another example network architecture 300 in accordance with various embodiments of the disclosure is shown. The embodiments shown in FIG. 3 may illustrate a scenario where the network architecture 300 may include a core network 302 coupled with a first edge device 304. The core network 302 may include a plurality of intermediate network devices 306-312. The plurality of intermediate network devices 306-312 may form a plurality of channels/paths/routes between the first edge device 304 and a second edge device 314.

In numerous embodiments, the first edge device 304 may include a first processor, a first network interface controller, and a first memory coupled to the first processor. The first memory may include a network tracing logic that when executed by the first processor can perform one or more operations for load balancing.

In many embodiments, the second edge device 314 may include a second processor, a second network interface controller, and a second memory coupled to the second processor. The second memory may include a routing logic that when executed by the second processor can perform one or more operations for load balancing.

In a number of embodiments, the first edge device 304 may receive a packet 316. The packet 316 may include a packet header PH and a payload PL. The first edge device 304 may encapsulate the packet 316 to obtain an encapsulated packet 318. As shown, the encapsulated packet 318 may include an outer header OH encapsulating the packet 316. The outer header OH may include various fields of which a source address field 320 having a source address, a destination address field 322 having a destination address, a flow label field 324, and a next header field 326 are shown. The source address in the source address field 320 may be an IP address or a MAC address of a source of the packet 316. The destination address in the destination address field 322 may be an IP address or a MAC address of a destination of the packet 316. The flow label field 324 may include a plurality of bits, for example, bits B₀-B₁₉. The plurality of bits B₀-B₁₉ may include one or more entropy bits. For example, the bits B₀-B₁₅ may be designated as entropy bits B₀-B₁₅.

In numerous embodiments, the entropy bits B₀-B₁₅ of various packets (e.g., data packets or probe packets) associated with the same traffic flow may be set to have the same entropy value. For example, the first edge device 304 may designate unique entropy values to different traffic flow identifiers. A traffic flow identifier may be an identifier utilized for uniquely identifying a traffic flow. Thus, the first edge device 304 may recognize a traffic flow identifier associated with the encapsulated packet 318 and may update the entropy bits B₀-B₁₅ to indicate the entropy value designated to the recognized traffic flow identifier. In a scenario where the recognized traffic flow identifier is a new identifier, the first edge device 304 may designate a new entropy value to the recognized traffic flow identifier and update the entropy bits B₀-B₁₅ of the encapsulated packet 318 accordingly. Further, the packets with the same entropy value may have to be routed via the same path.

Notably, transit routers, when determining load balancing keys for a packet, first extract the outer header fields and then traverse the next header field 326, and if a next header (e.g., the packet header PH) is recognized based on the next header field 326, the transit routers may leverage fields of the packet headers determining load balancing keys.

However, in the present disclosure, the first edge device 304 upon determining a requirement to exempt the packet header PH from load balancing operations, the first edge device 304 may obfuscate the next header field 326. The first edge device 304 may determine such a requirement based on a set of flow parameters. The first edge device 304 may receive the set of flow parameters from a source of the packet 316. The set of flow parameters may include an SLA parameter. The SLA parameters may be indicative of one or more constraints that may have to be adhered to while communicating the packet 316. In an example, the set of flow parameters may include a maximum allowed latency associated with the communication of the packet 316, a geographical location associated with storage of data within the packet 316, a hop limit associated with the communication of the packet 316, or the like. In an example, if the set of flow parameters may indicate that the packet 316 is a probe packet, the first edge device 304 may detect the requirement to obfuscate the next header field 326. Thus, restricting the load balancing operations exclusively to the outer header OH.

In a variety of embodiments, when the set of flow parameters indicates the requirement to obfuscate the next header field 326, the first edge device 304 may obfuscate a value of the next header field 326. For obfuscating the next header field 326, the first edge device 304 may set the next header value in the next header field 326 to an unrecognized header type.

In numerous additional embodiments, the first edge device 304 may transmit the encapsulated packet 318 to the intermediate network device 306. The intermediate network device 306 may read/parse the outer header OH of the encapsulated packet 318. The intermediate network device 306 may be unable to recognize/read the value of the next header field 326 due to obfuscation by the first edge device 304. Therefore, the intermediate network device 306 may be unable to access the packet header PH in the encapsulated packet 318. Hence, the packet header PH may be exempted from utilization for performing load balancing of the encapsulated packet 318. Subsequently, the intermediate network device 306 may perform a load balancing operation on the encapsulated packet 318 based on the outer header OH. For load balancing, the intermediate network device 306 may determine a load balancing vector for the encapsulated packet 318. For example, the intermediate network device 306 may determine the load balancing vector for the encapsulated packet 318 based on the source address field 320, the destination address field 322, and the flow label field 324 (e.g., the entropy bits B₀-B₁₅). Further, the intermediate network device 306 may generate a load balancing key (for example, a hash value) based on the load balancing vector. In an example, the intermediate network device 306 may utilize a hash-based routing technique to generate the load balancing key from the load balancing vector. The intermediate network device 306 may then utilize the load balancing key to determine a next hop (e.g., any of the intermediate network devices 308-312) for the encapsulated packet 318. For example, the intermediate network device 306 may use the hash value and determine that the next hop for the encapsulated packet 318 is the intermediate network device 308.

Likewise, the intermediate network device 308 may also determine a load balancing key for the encapsulated packet 318 based on the outer header OH and route the encapsulated packet 318 to the second edge device 314. The second edge device 314 may further transmit the packet 316, after de-encapsulation, to a destination of the packet 316.

Since the outer headers OH of a probe packet and a data packet associated with the same traffic flow are identical, load balancing keys determined for the data packet and the probe packet exclusively based on the outer header OH may also be the same. Hence, the intermediate network devices 306-312 may route the data packets and the probe packets of the same traffic flow via the same path.

Although a specific embodiment for an example network architecture with load balancing suitable for carrying out the various steps, processes, methods, and operations described herein is discussed with respect to FIG. 3, any of a variety of systems and/or processes may be utilized in accordance with embodiments of the disclosure. For example, the next header field 326 in the outer header OH of the encapsulated packet 318 may have a ‘No next header’ value. Notably, the ‘No next header’ value of the next header field 326 may indicate absence of an inner/packet header in the encapsulated packet 318. Therefore, the load balancing for the encapsulated packet 318 may be performed exclusively based on the outer header OH. Thus, exempting a utilization of the packet header PH from the load balancing operations at next hops. The elements depicted in FIG. 3 may also be interchangeable with other elements of FIGS. 1, 2, and 4-9 as required to realize a particularly desired embodiment.

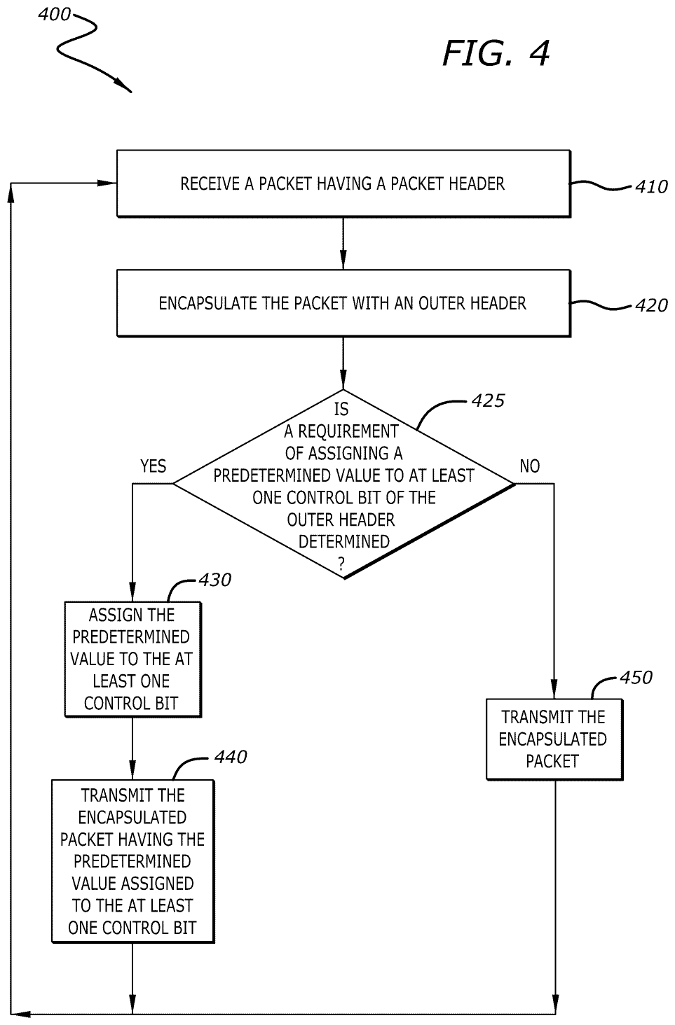

Referring to FIG. 4, a flowchart showing a process 400 for load balancing in a multi-path network in accordance with various embodiments of the disclosure is shown. In many embodiments, the process 400 may receive a packet having a packet header (block 410). The packet may be received from a source of the packet. The packet may include the packet header and a payload. The packet header may include a source address, a destination address, a protocol, a port number, or the like, associated with the packet. In an example, the packet can be a probe packet associated with a traffic flow. In many additional examples, the packet can be a data packet associated with the traffic flow for which a probe packet is sent.

In a number of embodiments, the process 400 may encapsulate the packet with an outer header (block 420). The outer header may include the source address, the destination address, and a flow label field. The source address may be an IP address or a MAC address of a source of the packet. The destination address may be an IP address or a MAC address of a destination of the packet. The flow label field may include a plurality of bits. The plurality of bits may include a control bit and one or more entropy bits. In many examples, the packet header can be associated with a first communication protocol (for example, IPv4) and the outer header can be associated with a second communication protocol (for example, IPv6) different from the first communication protocol.

In a variety of embodiments, the process 400 may determine whether there is a requirement of assigning a predetermined value to the control bit of the outer header (block 425). The process 400 may determine such a requirement based on a set of flow parameters associated with the packet. The set of flow parameters may include an SLA parameter. The SLA parameters may be indicative of one or more constraints that may have to be adhered to while communicating the packet. In an example, the set of flow parameters may include a maximum allowed latency associated with the communication of the packet, a geographical location associated with storage of data within the packet, and a hop limit associated with the communication of the packet.

In additional embodiments, if the set of flow parameters indicates a requirement to assign the predetermined value to the control bit, the process 400 may assign the predetermined value to the control bit (block 430). In many examples, the control bit can be a Boolean value such as ‘0’ or ‘1’, ‘SET’ or ‘UNSET’, ‘True’ or ‘False’. In such a scenario, the predetermined value can be ‘SET’, ‘True’, or ‘1’. The predetermined value assigned to the control bit may indicate that a load balancing operation on the packet is to be performed exclusively based on the outer header, exempting the utilization of the inner header for the load balancing operation.

In numerous embodiments, the process 400 may transmit the encapsulated packet having the predetermined value assigned to the control bit, for example, to a next hop (block 440). The predetermined value assigned to the control bit may indicate to the next hop that the packet header of the encapsulated packet should be exempted from use during the load balancing operation for the packet. In other words, the predetermined value assigned to the control bit may indicate that the next hop for the packet is to perform the load balancing operation on the packet exclusively based on the outer header. The process 400 may continue receiving new packets having packet headers (block 410).

In more embodiments, if the set of flow parameters does not indicate a requirement to assign the predetermined value to the control bit, the process 400 may transmit the encapsulated packet, for example, to a next hop (block 450). In other words, the process 400 may transmit the encapsulated packet in which the predetermined value is not assigned to the control bit. For example, in such a scenario, the control bit can have values such as ‘0’, ‘UNSET’ or ‘False’. The process 400 may continue receiving new packets having packet headers (block 410).

Although a specific embodiment for load balancing in a multi-path network suitable for carrying out the various steps, processes, methods, and operations described herein is discussed with respect to FIG. 4, any of a variety of systems and/or processes may be utilized in accordance with embodiments of the disclosure. For example, in many further embodiments, the process 400, upon receiving the packet, may communicate a nudge signal to a source of the packet. The nudge signal may be indicative of an instruction to communicate the set of flow parameters. The source of the packet may communicate the set of flow parameters based on the reception of the nudge signal. The elements depicted in FIG. 4 may also be interchangeable with other elements of FIGS. 1-3 and 5-9 as required to realize a particularly desired embodiment.

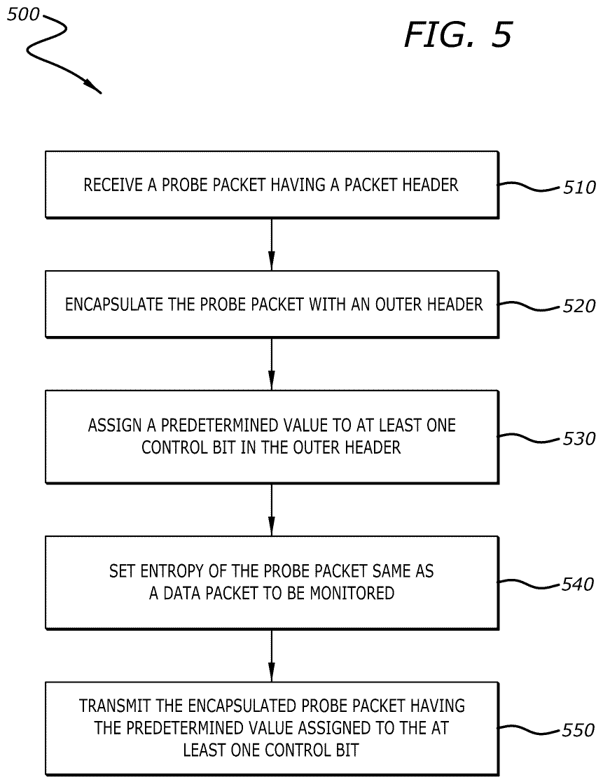

Referring to FIG. 5, a flowchart showing a process 500 for enabling path monitoring in a multi-path network using probe packets in accordance with various embodiments of the disclosure is shown. In many embodiments, the process 500 may receive a probe packet having a packet header (block 510). In various embodiments, the probe packet may be associated with a traffic flow for which path monitoring is required prior to transmitting data packets of the traffic flow. The probe packet may be received from a source of the traffic flow. The probe packet may include the packet header and a payload. The packet header may include a source address, a destination address, a protocol, or the like, associated with the probe packet.

In a variety of embodiments, the process 500 may encapsulate the probe packet with an outer header (block 520). The outer header may include a source address field, a destination address field, and a flow label field. The source address field may include an IP address or a MAC address of a source of the probe packet. The destination address field may include an IP address or a MAC address of a destination of the probe packet. The flow label field may include a plurality of bits. For example, the plurality of bits may include a control bit and one or more entropy bits. In many examples, the packet header may be associated with a first communication protocol (for example, IPv4) and the outer header may be associated with a second communication protocol (for example, IPv6) different from the first communication protocol.

In several embodiments, the process 500 may assign a predetermined value to the control bit in the outer header (block 530). In numerous embodiments, the process 500 may assign the predetermined value to the control bit based on determining that the received packet is a probe packet. In many examples, the control bit can be a Boolean value such as ‘0’ or ‘1’, ‘SET’ or ‘UNSET’, ‘True’ or ‘False’. In such a scenario, the predetermined value can be ‘SET’, ‘True’, or ‘1’. The predetermined value assigned to the control bit may indicate that a load balancing operation on the probe packet is to be performed exclusively based on the outer header, exempting the utilization of the inner header for the load balancing operation.

In more embodiments, the process 500 may set the entropy of the probe packet same as a data packet to be monitored (block 540). In yet numerous embodiments, the process 500 may designate unique entropy values to different traffic flow identifiers. A traffic flow identifier may be an identifier utilized for uniquely identifying a traffic flow. Thus, the process 500 may recognize a traffic flow identifier associated with the probe packet and may update the entropy bits in the flow label field to indicate the entropy value designated to the recognized traffic flow identifier. Further, as and when the data packets associated with the traffic flow are received, the process 500 may set the entropy of the data packets same as the probe packet, ensuring the data packets are also routed through the same path monitored by the probe packet.

In additional embodiments, the process 500 may transmit the encapsulated probe packet having the predetermined value assigned to the control bit (block 550). The process 500 may transmit the encapsulated probe packet to a next hop in the path. The next hop may determine, based on the predetermined value of the control bit, that the packet header of the probe packet is to be exempted from utilization during load balancing operations. Therefore, the outer header of the encapsulated probe packet is used for performing the load balancing operations.

Although a specific embodiment for load balancing of probe packets for monitoring data packets for carrying out the various steps, processes, methods, and operations described herein is discussed with respect to FIG. 5, any of a variety of systems and/or processes may be utilized in accordance with embodiments of the disclosure. For example, in still further embodiments, a source of the probe packet may communicate an entropy value to be assigned to the probe packet. The elements depicted in FIG. 5 may also be interchangeable with other elements of FIGS. 1-4 and 6-9 as required to realize a particularly desired embodiment.

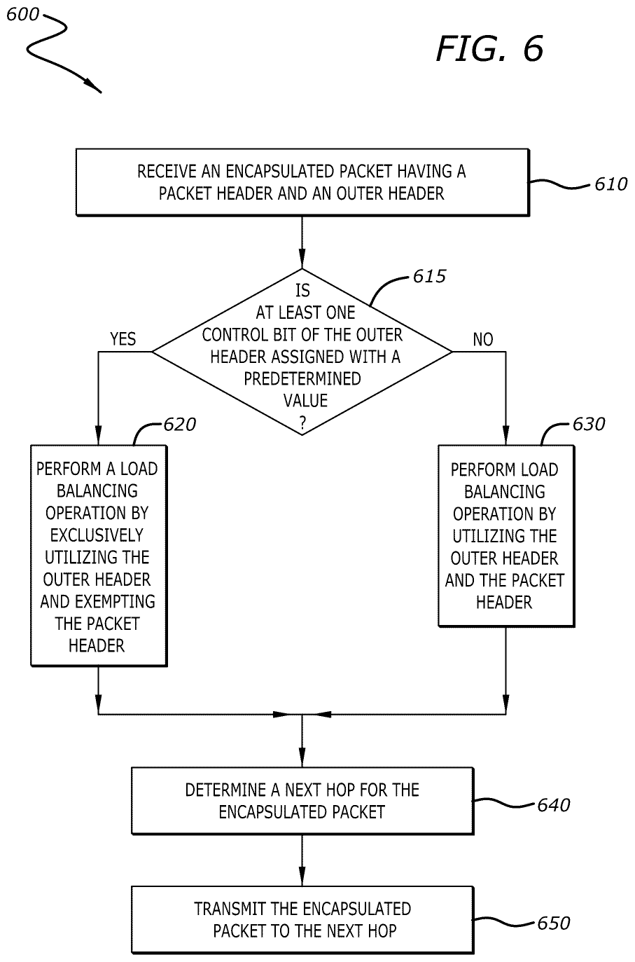

Referring to FIG. 6, a flowchart showing a process 600 for routing a packet in a multi-path network in accordance with various embodiments of the disclosure is shown. In many embodiments, the process 600 may receive an encapsulated packet having a packet header and an outer header (block 610). The process 600 may receive the encapsulated packet from an edge device or an intermediate network device. The outer header may include, for example, a source address field, a destination address field, and a flow label field. The flow label field may include a plurality of bits, for example, at least one control bit and one or more entropy bits.

In a number of embodiments, the process 600 may determine whether the at least one control bit in the outer header has been assigned with a predetermined value (block 615). The process 600 may parse the outer header of the encapsulated packet to determine a current value of the control bit. The process 600 may be aware of the predetermined value. The process 600 may compare the current value of the control bit with the predetermined value. Based on a match of the current value of the control bit with the predetermined value, the process 600 may determine that the control bit in the outer header has been assigned with the predetermined value.

In a variety of embodiments, if the control bit in the outer header is assigned with the predetermined value, the process 600 may perform a load balancing operation by exclusively utilizing the outer header of the packet and exempting the packet header of the packet (block 620). In other words, the process 600 may perform the load balancing operation based on the content of the outer header. For the load balancing operation, the process 600 may utilize the source address field, the destination address field, and the flow label field (e.g., the one or more entropy bits) for building one or more load balancing keys for the encapsulated packet.

In additional embodiments, the process 600 may determine a next hop for the encapsulated packet (block 640). The process 600 may determine the next hop for the packet based on the load balancing operation. In many examples, the next hop can be associated with the lowest cost path in the multi-path network.

In more embodiments, if the control bit in the outer header is not assigned with the predetermined value, the process 600 may perform a load balancing operation by utilizing the outer header and the packet header (block 630). In additional embodiments, the process 600 may determine a next hop for the encapsulated packet (block 640) and transmit the encapsulated packet to the next hop (block 650).

Although a specific embodiment for routing packets for carrying out the various steps, processes, methods, and operations described herein is discussed with respect to FIG. 6, any of a variety of systems and/or processes may be utilized in accordance with embodiments of the disclosure. For example, in further embodiments, the process 600 may utilize a subrange of the source address field, the destination address field, and the flow label field in the outer header during the load balancing operation. The elements depicted in FIG. 6 may also be interchangeable with other elements of FIGS. 1-5 and 7-9 as required to realize a particularly desired embodiment.

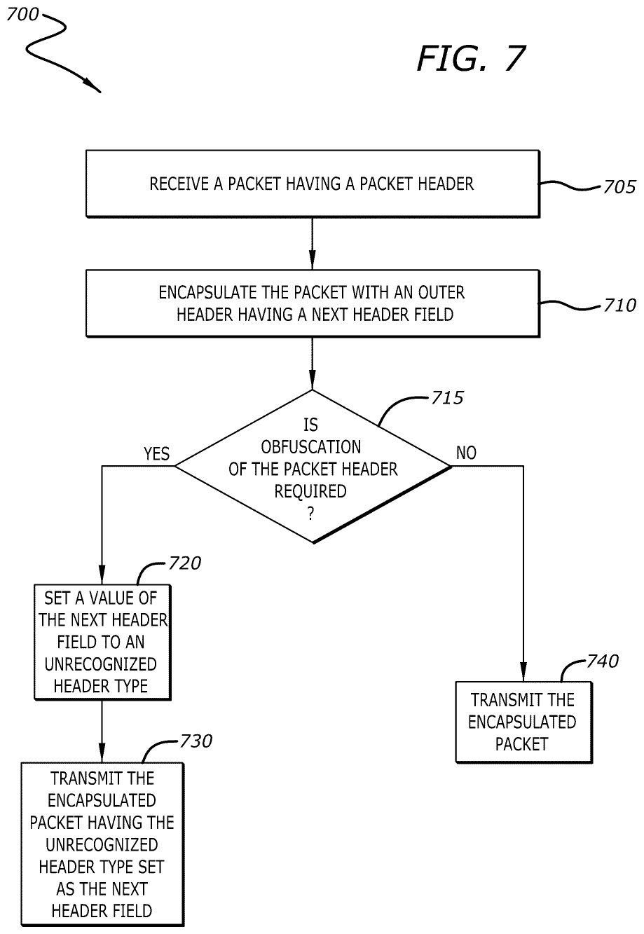

Referring to FIG. 7, a flowchart showing a process 700 for load balancing in a multi-path network in accordance with various embodiments of the disclosure is shown. In many embodiments, the process 700 may receive a packet having a packet header (block 705). The packet may be received from a source of the packet. The packet may include a packet header and a payload. In various embodiments, the packet can be a probe packet or a data packet, associated with a traffic flow.

In a number of embodiments, the process 700 may encapsulate the packet with an outer header (block 710). The outer header may include a source address field, a destination address field, a flow label field, and a next header field. The flow label field may include a plurality of bits. The plurality of bits may include at least one control bit and one or more entropy bits. The next header field may be a pointer, a bit number, a reference, or the like to the packet header.

In a variety of embodiments, the process 700 may determine whether there is a requirement for obfuscation of the packet header (block 715). The process 700 may determine such a requirement based on a set of flow parameters. The set of flow parameters may include an SLA parameter. The SLA parameters may be indicative of one or more constraints that may have to be adhered to while communicating the packet. In several embodiments, the set of flow parameters may indicate whether a probing operation is performed for the traffic flow.

In additional embodiments, if obfuscation of the packet header is required, the process 700 may set a value of the next header field to an unrecognized header type (block 720). Notably, the unrecognized value type may indicate that the packet header is unrecognized or unavailable and may not be usable. In many examples, obfuscation of the packet header may be required when the probing operation is performed for the traffic flow. Such obfuscation of the packet header is required to ensure that the data packets and the probe packets of the traffic flow are routed via the same path.

In numerous embodiments, the process 700 may transmit the encapsulated packet having the unrecognized header type set as the next header field (block 730). The next header field with the unrecognized header type may not allow a subsequent hop to leverage the packet header or any other portion (for example, internal metadata) of the encapsulated packet, except for the outer header, for performing load balancing. Hence, load balancing operations at subsequent hops are performed exclusively based on the outer header while exempting the packet header.

In more embodiments, if obfuscation of the packet header is not required, the process 700 may transmit the encapsulated packet to a next hop (block 740). In such a scenario, the next header field in the outer header may not be set to an unrecognized header type. Hence, load balancing operations at subsequent hops can be performed based on the outer header and the packet header.

Although a specific embodiment for load balancing suitable for carrying out the various steps, processes, methods, and operations described herein is discussed with respect to FIG. 7, any of a variety of systems and/or processes may be utilized in accordance with embodiments of the disclosure. For example, in many further embodiments, the process 700 may set the value of the next header field as ‘Null’. ‘Null’ value of the next header field may leave the packet header inaccessible. Hence, the load balancing of the packet may be performed solely based on the outer header of the encapsulated packet. The elements depicted in FIG. 7 may also be interchangeable with other elements of FIGS. 1-6 and 8-9 as required to realize a particularly desired embodiment.

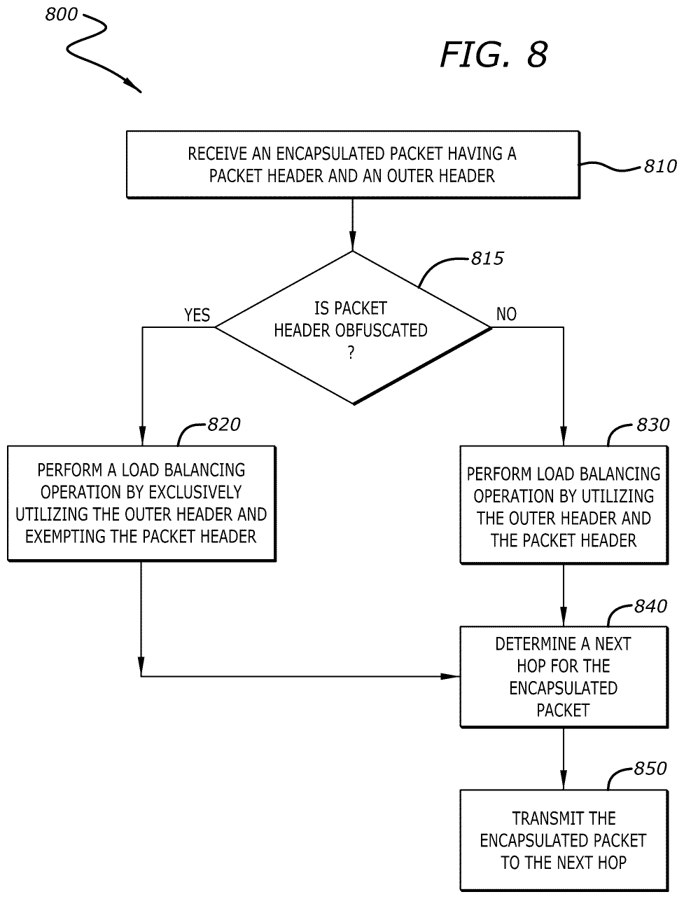

Referring to FIG. 8, a flowchart showing a process 800 for routing a packet in a multi-path network in accordance with various embodiments of the disclosure is shown. In many embodiments, the process 800 may receive an encapsulated packet having a packet header and an outer header (block 810). The process 800 may receive the encapsulated packet from an edge device or an intermediate network device.

In a number of embodiments, the process 800 may determine whether the packet header is obfuscated (block 815). The process 800 may check the contents of the outer header of the encapsulated packet to determine a value of a next header field in the outer header. The process 800 may determine that the next header field includes an unrecognized value. Based on the unrecognized value in the next header field, the process 800 may determine that the packet header of the packet is obfuscated.

In a variety of embodiments, if the packet header is obfuscated, the process 800 may perform a load balancing operation by exclusively utilizing the outer header of the packet and exempting the packet header of the packet (block 820). The process 800 may perform the load balancing operation based on the content of the outer header. The outer header may include a source address field, a destination address field, and a flow label field. The process 800 may determine a load balancing key for the packet based on the source address field, the destination address field, and the flow label field in the outer header. Since probe packets and data packets associated with the same traffic flow have identical encapsulation (e.g., the source address field, the destination address field, and the flow label field), the load balancing keys determined for the probe packets and the data packets are same, resulting in consistent hashing and packet routing. Thus, the process 800 ensures that packets associated with the same data traffic get routed across the same path.

In more embodiments, if the packet header of the packet is not obfuscated, the process 800 may perform a load balancing operation by utilizing the outer header and the packet header of the packet (block 830). For example, a load balancing key for the packet can be built based on fields from Layer 3 and Layer 4 (of Open Systems Interconnection “OSI” model) headers of the outer header, as well as fields from Layer 3 and Layer 4 headers of the packet header.

In some embodiments, the process 800 may determine a next hop for the encapsulated packet (block 840). The process 800 may determine the next hop for the packet based on the determined load balancing key. For example, the process 800 may utilize a hash-based routing technique to determine the next hop for the encapsulated packet. In numerous embodiments, the process 800 may transmit the encapsulated packet to the next hop (block 850).

Although a specific embodiment for load balancing in multi-path networks for carrying out the various steps, processes, methods, and operations described herein is discussed with respect to FIG. 8, any of a variety of systems and/or processes may be utilized in accordance with embodiments of the disclosure. For example, in further embodiments, an edge device, associated with a destination of the encapsulated packet, may be configured to decapsulate the encapsulated packet prior to transmitting the packet to the destination. The elements depicted in FIG. 8 may also be interchangeable with other elements of FIGS. 1-7 and 9 as required to realize a particularly desired embodiment.

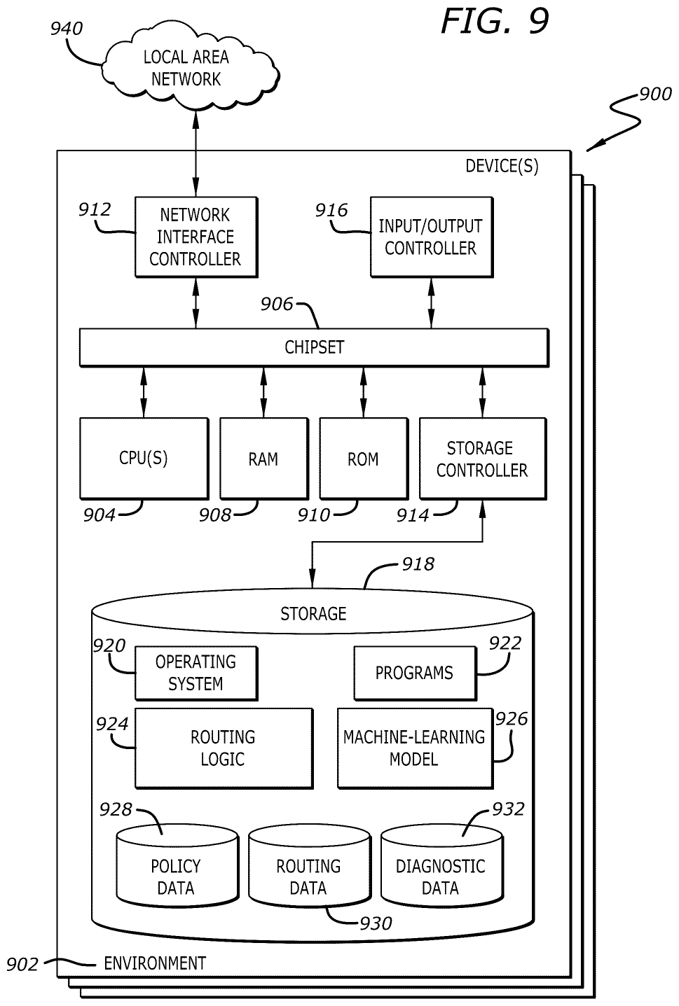

Referring to FIG. 9, a conceptual block diagram of a device 900 suitable for configuration with a routing logic, in accordance with various embodiments of the disclosure is shown. The embodiment of the conceptual block diagram depicted in FIG. 9 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 9 can also illustrate an access point, a switch, or a router in accordance with various embodiments of the disclosure. The device 900 may, in many nonlimiting examples, correspond to physical devices or virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In a number of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

In additional embodiments, the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for instance, store an operating system 920, applications 922, policy data 928, routing data 930, and diagnostics data 932 which are described in greater detail below. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of the physical state can depend on various factors. Examples of such factors can include, but are not limited to, the technology used to implement the physical storage units, whether the storage 918 is characterized as primary or secondary storage, and the like.

In many more embodiments, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more devices 900 operating in a cloud-based arrangement. By way of example, and not limitation, computer-readable storage media can include volatile and non-volatile, removable and non-removable media implemented in any method or technology.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In many additional embodiments, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as application 922 and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-8. In certain embodiments, the device 900 can also include computer-readable storage media having instructions stored thereupon for performing any of the other computer-implemented operations described herein.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9 and can include other components that are not explicitly shown in FIG. 9 or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform the functions described herein. The virtualization layer may generally support a virtual resource that performs at least a portion of the techniques described herein.

In many further embodiments, the device 900 may include a routing logic 924. The routing logic 924 can be configured to perform one or more of the various steps, processes, operations, and/or other methods that are described above. Often, the routing logic 924 can be a set of instructions stored within a non-volatile memory that, when executed by the processor(s)/controller(s) 904 can carry out these steps, etc. In various embodiments, the routing logic 924 may perform various operations related to load balancing in multi-path networks. The routing logic 924 may be configured to receive a packet with a packet header. The routing logic 924 may be further configured to encapsulate the packet with an outer header having a source address field, a destination address field, and a flow label field. The flow label field may include at least one control bit and one or more entropy bits. The routing logic 924 may be further configured to determine whether there is a requirement for the packet to have the control bit set to a predetermined value. Based on the determination of such a requirement, the routing logic 924 may be configured to set the control bit in the outer header to the predetermined value. The predetermined value of the control bit may indicate that load balancing operations at subsequent hops may be performed exclusively based on the outer header of the packet and the packet header may be exempted from utilization for the load balancing operations. The routing logic 924 may be further configured to set the entropy bits of a probe packet same as entropy bits in data packets of the same traffic flow. Entropy bits may represent a unique entropy value assigned to a traffic flow. Thus, all packets, be it probe packets or data packets associated with the same traffic flow, have the same entropy value.

In a number of embodiments, the storage 918 can include policy data 928. In additional embodiments, the policy data 928 can include information, for example, a set of flow parameters. The set of flow parameters may include SLAs to be adhered to while transmitting data associated with a corresponding payload. The set of flow parameters may also include various other requirements such as network diagnosis, network troubleshooting, delay point detection, path discovery, or the like for which load balancing and monitoring of packets may be required.

In several embodiments, the policy data 928 can further comprise information regarding access control lists. Access control lists may delineate a set of rules that determine what type of traffic is allowed or denied on the network. The set of rules can be based on various criteria such as source or destination IP addresses, port numbers, or communication protocols. In several more embodiments, the policy data 928 can include QoS policies. For example, QoS policies can be used to prioritize certain types of traffic (e.g., encoding objects and error response packets) over others to ensure that critical applications receive the required latency requirements. In numerous additional embodiments, the policy data 928 can further include security policies, authentication and authorization policies, or the like.

In yet more embodiments, the storage 918 can include routing data 930. The routing data 930 may include a routing table. The routing table may contain various entries that map destination IP addresses to next hops or outgoing ports. Routing tables may enable the device 900 in making packet forwarding decisions. MAC address table is an example of a routing table. MAC address table may include destination MAC addresses mapped to corresponding switch ports. The routing data 930 may further store a mapping between IP addresses and MAC addresses within a network. Such mapping may be utilized to translate IP addresses to MAC addresses for proper forwarding of packets.

In various embodiments, the storage 918 can include diagnostics data 932. The diagnostics data 932 may include data associated with historical diagnosis and troubleshooting performed by the device 900. The diagnostics data 932 may further include a list of paths, payloads, or the like that are to be monitored. Additionally, the diagnostics data 932 may include a schedule of diagnostic operations and/or troubleshooting operations that may be required to be performed by the device 900.

Finally, in numerous additional embodiments, data may be processed into a format usable by a machine-learning model 926 (e.g., feature vectors), and or other pre-processing techniques. The machine-learning (“ML”) model 926 may be any type of ML model, such as supervised models, reinforcement models, and/or unsupervised models. The ML model 926 may include one or more linear regression models, logistic regression models, decision trees, Naïve Bayes models, neural networks, k-means cluster models, random forest models, and/or other types of ML models 926. The ML model(s) 926 can be configured to generate inferences to make predictions or draw conclusions from data. An inference can be considered the output of a process of applying a model to new data. This can occur by learning from at least the policy data 928, the routing data 930, and the diagnostics data 932, and utilizing the learning to predict future outcomes.

For example, the ML model(s) 926 can be trained to predict a requirement to perform troubleshooting or diagnostics of a network based on the diagnostics data 932. The ML model(s) 926 may be configured to correlate various routes in the routing data 930 and historical diagnostics/troubleshooting data in the diagnostic data 932. Based on the correlation, the ML model(s) 926 may determine patterns of troubleshooting or diagnostics requirements for each of the various routes. Based on the determined patterns, the ML model(s) 926 may deduce one or more rules based on which the ML model(s) 926 may predict the troubleshooting or diagnostics requirements of the various paths in the network. The device 900 may perform the predicted troubleshooting or diagnostics of the various paths in the network by communicating probe packets that may monitor data packets being routed via the various routes.

These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes.

Although a specific embodiment for a device suitable for configuration with a dynamic proxying logic for carrying out the various steps, processes, methods, and operations described herein is discussed with respect to FIG. 9, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 9 may also be interchangeable with other elements of FIGS. 1-8 as required to realize a particularly desired embodiment.

Although a specific embodiment for a conceptual block diagram of the device 900 suitable for configuration with the power management logic suitable for carrying out the various steps, processes, methods, and operations described herein is discussed with respect to FIG. 9, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 9 may also be interchangeable with other elements of FIGS. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more. ” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a network interface controller configured to provide access to a network; and
a memory communicatively coupled to the processor, wherein the memory comprises a routing logic that is configured to:
receive a packet having a packet header;
encapsulate the packet with an outer header, wherein the outer header includes at least one control bit;
assign a predetermined value to the at least one control bit, wherein the at least one control bit having the predetermined value is configured to exempt a utilization of the packet header from a load balancing operation at a next hop; and
transmit the encapsulated packet to the next hop.

2. The device of claim 1, wherein the at least one control bit having the predetermined value is further configured to indicate a utilization of the outer header for the load balancing operation at the next hop.

3. The device of claim 2, wherein the outer header comprises at least one of a Flow Label field or a Type of Service (ToS) field.

4. The device of claim 3, wherein the at least one control bit is included in the Flow Label field.

5. The device of claim 3, wherein the at least one control bit is included in the ToS field.

6. The device of claim 3, wherein the outer header further comprises at least one of a source address field or a destination address field.

7. The device of claim 6, wherein the at least one control bit having the predetermined value is further configured to indicate a utilization of at least one of the source address field, the destination address field, and the Flow Label field, in the outer header, for the load balancing operation at the next hop.

8. The device of claim 1, wherein prior to assigning the predetermined value to the at least one control bit, the routing logic is further configured to determine a requirement to assign the predetermined value to the at least one control bit.

9. The device of claim 8, wherein the routing logic is further configured to determine the requirement to assign the predetermined value to the at least one control bit based on a set of flow parameters.

10. The device of claim 9, wherein the set of flow parameters includes a service level agreement parameter.

11. The device of claim 1, wherein the packet corresponds to a data packet.

12. The device of claim 1, wherein the packet corresponds to a probe packet.

13. The device of claim 12, wherein the probe packet is configured to monitor a path traversed by a data packet in the network.

14. The device of claim 13, wherein the routing logic is further configured to set an entropy of the probe packet same as the data packet.

15. A device, comprising:
a processor;
a network interface controller configured to provide access to a network; and
a memory communicatively coupled to the processor, wherein the memory comprises a routing logic that is configured to:
receive an encapsulated packet comprising a packet header and an outer header, wherein the outer header includes at least one control bit;
determine whether the at least one control bit is assigned with a predetermined value; and
perform a load balancing operation on the encapsulated packet by exclusively utilizing the outer header in response to determining that the at least one control bit is assigned with the predetermined value.

16. The device of claim 15, wherein the at least one control bit having the predetermined value is configured to exempt a utilization of the packet header from the load balancing operation.

17. The device of claim 16, wherein the routing logic is further configured to transmit the encapsulated packet to a next hop based on the load balancing operation.

18. The device of claim 15, wherein the outer header comprises a source address field, a destination address field, and a Flow Label field.

19. The device of claim 18, wherein the routing logic performs the load balancing operation based on at least one of the source address field, the destination address field, and the Flow Label field, of the outer header.

20. A method, comprising:
receiving a packet having a packet header;
encapsulating the packet with an outer header, wherein the outer header includes at least one control bit;
assigning a predetermined value to at least one of the at least one control bit or a next header field, wherein the at least one control bit having the predetermined value is configured to exempt a utilization of the packet header from a load balancing operation at a next hop; and
transmitting the encapsulated packet to the next hop.
